(19) United States
(12) Patent Application Publication
(10) Pub. No.: US 2026/0157511 A1
(43) Pub. Date: Jun. 11, 2026

(54) SELF-STANDING PUSH BROOM WITH INTEGRATED SUPPORT BRACE AND METHOD FOR USING THE SAME

(71) Applicant: Nicholas French, Douglas, MI (US)

(72) Inventor: Nicholas French, Douglas, MI (US)

(21) Appl. No.: 19/414,910

(22) Filed: Dec. 10, 2025

Related U.S. Application Data
(60) Provisional application No. 63/730,504, filed on Dec. 11, 2024.

(51) Int. Cl. A46B 15/00; A46B 5/00; B25G 1/10

(52) U.S. Cl. CPC A46B 15/0097; A46B 5/0095; A46B 15/0081; A46B 15/0095; B25G 1/10; A46B 2200/302

(57) ABSTRACT

A push broom apparatus includes an elongated handle connected to a broom head having bristles, and a support brace having a first end portion connected adjacent the junction between the handle and broom head. The support brace extends away from the handle axis such that a second end portion engages a ground surface to support the push broom in a freestanding upright orientation. The support brace may be fixed or pivotably mounted for movement between stowed and deployed positions, with a cam lock mechanism securing the deployed position. A mounting plate secures the support brace assembly to the broom head, and a handle socket defines a non-circular aperture receiving the handle in a rotationally fixed relationship. A scraper feature enables removal of adhered debris. The freestanding capability eliminates repetitive bending to retrieve the broom from the ground during pauses in cleaning operations.

### COPYRIGHT NOTICE

This application includes material that is subject to copyright protection. The copyright owner has no objection to the facsimile reproduction by anyone of the patent disclosure, as it appears in the United States Patent and Trademark Office files or records, but otherwise reserves all copyright rights whatsoever.

### CROSS-REFERENCE TO RELATED APPLICATIONS

This application claims the benefit of United States Provisional Application Ser. No. 63/730,504, entitled “Multifunctional Push Broom with Integrated Support Brace, Scraper, and Self-Standing Capability,” filed Dec. 11, 2024—all of which is hereby incorporated herein by reference in its entirety, including all references cited therein.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

### 1. Field of the Invention

The present invention relates generally to cleaning implements and tools, and more particularly to push brooms incorporating support brace systems that enhance structural integrity, durability, and functionality. Still more specifically, the invention pertains to push broom constructions wherein an integrated support brace extends between the handle and broom head to provide structural reinforcement at the head-to-handle connection point while simultaneously establishing a ground-engaging support that enables the broom to stand upright without external support. The invention further relates to support brace configurations incorporating scraper features for removal of adhered debris, and to methods for using such push broom apparatus in cleaning operations.

### 2. Background of the Invention

Push brooms are essential tools in both commercial and residential cleaning applications, serving as fundamental implements for maintaining cleanliness across a broad range of environments including warehouses, manufacturing facilities, retail establishments, garages, driveways, sidewalks, and patios. Despite their ubiquity and importance, traditional push broom designs suffer from several significant limitations that substantially impact their effectiveness, durability, and user experience. These limitations have persisted in the industry for decades, creating substantial inefficiencies and frustrations for users across virtually all application contexts.

One of the most critical issues plaguing conventional push brooms is the inherent weakness of the head-to-handle connection point. This crucial junction represents a primary failure mode in push broom construction, frequently failing under regular use conditions, particularly in demanding commercial and industrial settings where the tools endure constant, heavy use. The failure typically manifests as a gradual loosening of the connection, resulting in wobbling and reduced control during sweeping operations, or in more severe cases, complete separation of the broom head from the handle, rendering the tool ineffective or entirely unusable. The forces encountered during pushing and pulling motions create repetitive stress at this connection point, and conventional socket or ferrule-type connections lack adequate reinforcement to withstand these forces over extended service periods. Users in commercial environments frequently report broom handle failures occurring within weeks or months of initial deployment, necessitating premature replacement and increasing operational costs.

Beyond the structural weaknesses inherent in conventional push broom construction, traditional designs demonstrate a marked lack of versatility in handling different types of debris and cleaning challenges. Sweeping operations frequently encounter stuck-on materials, dried spills, compacted debris, and other adherent substances that resist removal by bristle action alone. Users confronting such materials must typically set aside the broom and retrieve a separate scraping tool, address the adhered material, then return to sweeping operations. This necessary tool-switching significantly reduces cleaning efficiency, increases the time required to complete cleaning tasks, and leads to decreased productivity and increased labor costs in commercial settings. The need to maintain and store multiple cleaning implements further compounds these inefficiencies.

The storage and accessibility of traditional push brooms present another set of significant challenges that impact both operational efficiency and workplace safety. Conventional push brooms are incapable of standing upright independently due to their inherent geometry, wherein the elongated handle extends from a relatively narrow broom head at an angle that precludes stable vertical orientation. As a result, these implements must be leaned against walls, placed in dedicated storage racks, or laid flat on the floor when not in active use. Leaning brooms against walls creates several problems: the broom may slide and fall, potentially damaging both the implement and surrounding surfaces; the bristles may become deformed from prolonged contact with the floor at an angle; and the leaning broom creates visual clutter in work environments. More significantly, leaning brooms present tripping hazards in workplace settings, raising safety concerns that employers must address through additional storage solutions, designated broom storage areas, or constant vigilance by workers. Floor-stored brooms similarly create tripping hazards and occupy valuable floor space. The need for dedicated storage racks or hooks requires capital expenditure, wall space allocation, and ongoing maintenance of storage infrastructure.

The limitations of conventional push brooms become particularly acute when users must work in open areas where walls or other vertical support surfaces are not readily accessible. Warehouses, parking structures, outdoor patios, driveways, sidewalks, gymnasium floors, and large retail spaces frequently present expansive open areas where the nearest wall may be a considerable distance from the active sweeping zone. In such environments, when a user must pause sweeping operations—whether to take a break, move an obstacle, answer a question, attend to another task, or address any of the myriad interruptions that occur during a typical work shift—the user has no practical option but to lay the broom flat on the ground. When ready to resume sweeping, the user must then bend down to retrieve the broom from the floor. This bending motion, repeated numerous times throughout a work shift, imposes significant cumulative strain on the user's lower back, knees, and legs. Studies of occupational ergonomics consistently identify repetitive bending and stooping as contributing factors to musculoskeletal disorders, chronic pain, and workplace injuries. The physical toll of repeatedly retrieving a floor-laid broom accumulates over days, weeks, and months of regular use, potentially resulting in long-term health consequences for workers whose duties include frequent sweeping tasks.

The workflow interruptions caused by the inability of conventional brooms to stand independently further compound operational inefficiencies. During cleaning operations, users frequently need to pause sweeping momentarily to address other tasks, answer questions, move obstacles, or attend to other matters. Each such pause requires the user to either walk to a wall or other support surface to lean the broom, or to lay the broom on the ground and later bend to retrieve it. These repeated interruptions, though individually brief, accumulate over the course of a work shift to represent substantial lost productivity. The physical act of bending to retrieve a floor-laid broom, while requiring only a few seconds per occurrence, may occur dozens of times during a single shift in environments with frequent task-switching demands. The cumulative time expenditure, combined with the physical strain of repetitive bending, significantly degrades overall work efficiency and worker wellbeing.

Furthermore, conventional push brooms often demonstrate insufficient ergonomic consideration in their design beyond the retrieval problem discussed above. The lack of structural reinforcement at the head-to-handle connection permits wobbling and flexing during use, requiring users to exert additional grip force and control effort to maintain effective sweeping action. This additional effort leads to user fatigue and potential strain during extended use periods, particularly in professional cleaning applications where the tool may be in constant use throughout a work shift. The combination of inadequate structural rigidity, poor storage characteristics, limited functionality, and the cumulative physical strain of repetitive bending creates a clear and pressing need for an improved push broom design that comprehensively addresses these challenges while maintaining cost-effectiveness and ease of manufacture.

### 3. Background Art

Brooms and broom components have been known in the art for years and are the subject of a plurality of patents and publications, including: U.S. Pat. No. 11,284,704 entitled “Push Broom Head and Method of Fabrication Thereof,” U.S. Pat. No. 10,244,859 entitled “Broom Attachment, Broom Assembly and Method for Use Thereof,” U.S. Pat. No. 9,364,074 entitled “Broom Having Arcuate Head,” U.S. Pat. No. 6,718,589 entitled “Spring Activated Push Broom,” U.S. Pat. No. 6,134,739 entitled “Push Broom Handle Brace,” U.S. Pat. No. 5,337,440 entitled “Tool Head Brace,” U.S. Pat. No. 4,792,256 entitled “Implement with Connector Joining Handle to Working Head,” United States Patent Application Publication Number 2006/0156499 entitled “Broom with a Flexible Neck,” United States Patent Application Publication Number 2006/0117511 entitled “Push Broom with Support Brace,” and United States Patent Application Publication Number 2004/0031116 entitled “Combination of Push Broom and House Broom”—all of which are hereby incorporated herein by reference in their entirety including all references cited therein.

While the above-identified patents and publications disclose various broom constructions and support brace arrangements, none appear to disclose an integrated support brace system that simultaneously provides structural reinforcement at the head-to-handle connection point while enabling the broom to stand upright independently through ground engagement of the brace, thereby eliminating the need for users to repeatedly bend down to retrieve the broom from the ground during pauses in cleaning operations. Furthermore, none of the above-identified references appear to disclose such a support brace system that additionally incorporates a scraper feature for removal of adhered debris. Accordingly, there exists a substantial and long-felt need in the cleaning implement industry for an improved push broom design that overcomes the limitations of existing devices by providing enhanced structural integrity, self-standing capability that eliminates repetitive bending motions, and multifunctional cleaning features in a single, integrated implement.

### SUMMARY OF THE INVENTION

The following presents a simplified summary in order to provide a basic understanding of some aspects of the claimed subject matter. This summary is not an extensive overview and is not intended to identify key or critical elements or to delineate the scope of the claimed subject matter. Its purpose is to present certain concepts in a simplified form as a prelude to the more detailed description that is presented later.

The present invention addresses the aforementioned deficiencies in existing push broom technology by providing a novel push broom apparatus incorporating an integrated support brace system that simultaneously provides structural reinforcement at the head-to-handle connection point, enables the broom to stand upright independently without external support, and optionally incorporates a scraper feature for removal of adhered debris from surfaces.

In one aspect, the invention provides a push broom apparatus comprising an elongated handle defining a handle axis and having a proximal end and a distal end, a broom head connected to the distal end of the handle with a plurality of bristles extending therefrom, and a support brace having a first end portion and a second end portion. The first end portion is connected adjacent a junction between the handle and the broom head, and the support brace extends away from the handle axis such that the second end portion is configured to engage a ground surface to support the push broom apparatus in a freestanding upright orientation. The freestanding capability eliminates the need for users to repeatedly bend down to retrieve the broom from the ground during pauses in cleaning operations, thereby reducing cumulative physical strain on the lower back, knees, and legs over extended work periods.

In certain embodiments, the push broom apparatus further comprises a handle socket disposed at the first end portion of the support brace, wherein the handle socket defines a non-circular aperture configured to receive the distal end of the handle in a rotationally fixed relationship. The non-circular aperture prevents relative rotation between the handle and the support brace, ensuring that the support brace maintains its proper orientation relative to the broom head and bristles during use. In particularly preferred embodiments, the non-circular aperture is hexagonal.

In certain embodiments, the support brace includes a scraper edge configured for removing adhered debris from a surface. The scraper feature enables users to address stuck-on materials, dried spills, and other adherent substances without requiring a separate scraping tool, thereby improving cleaning efficiency and reducing the need to maintain multiple cleaning implements.

In certain embodiments, the push broom apparatus further comprises a mounting plate connected to the first end portion of the support brace, wherein the mounting plate is secured to the broom head by at least one fastener. The mounting plate distributes attachment forces across a broader area of the broom head, enhancing the structural integrity of the connection and reducing the likelihood of localized failure. In certain preferred embodiments, at least one reinforcement gusset extends between the support brace and the mounting plate to further enhance structural rigidity.

In certain embodiments, the support brace extends at an acute angle relative to the handle axis when the push broom apparatus is in the freestanding upright orientation. The acute angle positions the second end portion of the support brace in contact with the ground surface at a location spaced from the broom head, creating a stable tripod-like configuration wherein the bristles and the support brace collectively support the weight of the push broom apparatus.

In a first embodiment, the support brace is fixedly connected to the mounting plate and extends at a predetermined angle relative to the handle axis. The fixed configuration provides a simple, robust construction with no moving parts, minimizing manufacturing complexity and potential failure modes while providing reliable self-standing capability.

In a second embodiment, the support brace is movable between a stowed position wherein the support brace is disposed generally parallel to the handle and a deployed position wherein the support brace extends away from the handle axis to enable the freestanding upright orientation. The movable configuration permits the support brace to be stowed during active sweeping operations, thereby preventing interference with the sweeping motion, and to be deployed when the user wishes to set the broom down in a freestanding orientation. In certain preferred configurations of the second embodiment, the support brace is pivotably connected to the mounting plate and a locking mechanism is provided to selectively secure the support brace in at least the deployed position. In particularly preferred configurations, the locking mechanism comprises a cam lock including a threaded fastener and an actuating handle, enabling rapid transition between the stowed and deployed positions with a simple manual operation.

In certain embodiments of the second embodiment, a scraper blade is disposed at a distal end of the brace member. The scraper blade provides a dedicated scraping surface optimally positioned for engaging adhered debris when the user applies downward and forward pressure on the handle. In alternative embodiments, a scraper edge is formed integrally with the brace member, providing scraping capability without requiring a separate blade component.

In certain embodiments, the brace member includes a waisted portion disposed between the proximal end and the distal end thereof. The waisted portion provides a transition between the wider mounting region at the proximal end and a narrower ground-engaging region at the distal end, reducing material usage and weight while maintaining adequate structural strength.

In certain embodiments, the brace member defines a channel configured to receive the handle when the brace member is in the stowed position. The channel permits the brace member to nest closely against the handle during sweeping operations, minimizing the profile of the stowed brace member and reducing the likelihood of interference with the user's grip or sweeping motion.

In another aspect, the invention provides a push broom apparatus comprising an elongated handle defining a handle axis, a broom head connected to the handle with bristles extending from a lower surface thereof, and a support brace assembly. The support brace assembly includes a mounting plate configured for attachment to an upper surface of the broom head, a handle socket connected to the mounting plate and defining a non-circular aperture configured to receive the distal end of the handle in a rotationally fixed relationship, a brace member having a proximal end connected to the mounting plate and a distal end spaced from the mounting plate with the brace member extending away from the handle axis, and a scraper feature disposed on the brace member. The distal end of the brace member is configured to engage a ground surface to support the push broom apparatus in a freestanding upright orientation.

In yet another aspect, the invention provides a complete push broom consisting of an elongated handle having a non-circular cross-sectional profile at its distal end, a broom head with bristles extending from a lower surface, and a support brace assembly including a mounting plate secured to the broom head, a handle socket defining a hexagonal aperture, a brace member pivotably connected to the mounting plate and movable between stowed and deployed positions, a cam lock mechanism configured to secure the brace member in the deployed position, and a scraper blade disposed at a distal end of the brace member. In the deployed position, the distal end of the brace member engages a ground surface to support the push broom in a freestanding upright orientation with the bristles contacting the ground surface.

In still another aspect, the invention provides a method of using a push broom comprising the steps of providing a push broom apparatus including an elongated handle connected to a broom head having bristles and a support brace connected adjacent a junction between the handle and broom head, sweeping a surface with the bristles, orienting the push broom apparatus such that the support brace extends away from the handle, and releasing the push broom apparatus whereby the support brace engages the surface and the push broom apparatus remains in a freestanding upright orientation. The method eliminates the need for the user to bend down to retrieve the broom from the ground when resuming sweeping operations after a pause.

In certain embodiments, the method further comprises the step of scraping adhered debris from the surface using a scraper feature disposed on the support brace. In certain embodiments, the method further comprises the steps of moving the support brace from a stowed position to a deployed position prior to releasing the push broom apparatus, and actuating a locking mechanism to secure the support brace in the deployed position.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted. It will be further understood that the invention is not necessarily limited to the particular embodiments illustrated herein. The invention will now be described with reference to the drawings wherein:

FIG. 1 is a perspective view of a push broom apparatus according to a first embodiment of the present invention, showing the broom in a use position suitable for sweeping operations.

FIG. 2 is an enlarged side elevation view of the push broom apparatus of FIG. 1, showing the broom in a self-standing position wherein the support brace engages a ground surface to maintain the broom in a freestanding upright orientation.

FIG. 3 is an enlarged top view of the support brace assembly according to the first embodiment, showing, among other things, the mounting plate, reinforcement gussets, and handle socket.

FIG. 4 is an enlarged side elevation view of the push broom apparatus according to the first embodiment, showing the internal structure of the support brace and its connection to the broom head and handle.

FIG. 5 is a perspective view of a push broom apparatus according to a second embodiment of the present invention, showing the broom in a use position.

FIG. 6 is an enlarged perspective view of the support brace assembly according to the second embodiment, showing the mounting plate, handle socket, brace member, and cam lock mechanism.

FIG. 7 is a top view of the support brace assembly according to the second embodiment, showing the handle socket defining a non-circular aperture and the channel formed in the brace member.

FIG. 8 is a side elevation view of the brace member according to the second embodiment, showing the scraper blade disposed at the distal end thereof.

FIG. 9 is a perspective view of the support brace assembly according to the second embodiment, showing the mounting plate and the cam lock mechanism.

FIG. 10 is a perspective view of the cam lock fastener according to the second embodiment, showing the actuating handle and threaded shaft.

FIG. 11 is a cross-sectional view of the cam lock fastener according to the second embodiment.

### REFERENCE NUMERALS

Reference numerals used throughout the detailed description and drawings correspond to the following elements:

Common Elements:
10—push broom apparatus
12—handle
14—handle axis
16—proximal end of handle
18—distal end of handle
20—broom head
22—upper surface of broom head
24—lower surface of broom head
26—first lateral end of broom head
28—second lateral end of broom head
30—bristles
32—support brace/support brace assembly
34—first end portion of support brace
36—second end portion of support brace
38—mounting plate
40—fastener
42—handle socket
44—non-circular aperture
46—scraper feature
48—ground surface
50—freestanding upright orientation

Embodiment 1 (Fixed Brace) Specific:
60—reinforcement gusset
62—scraper edge
64—hanging aperture

Embodiment 2 (Pivoting Brace) Specific:
70—brace member
72—proximal end of brace member
74—distal end of brace member
76—waisted portion
78—channel
80—pivot connection
82—locking mechanism
84—cam lock mechanism
86—threaded fastener
88—actuating handle
90—scraper blade
92—stowed position
94—deployed position

### DETAILED DESCRIPTION OF THE INVENTION

While this invention is susceptible of embodiment in many different forms and applications, there are shown in the drawings and described herein in detail several specific embodiments with the understanding that the present disclosure is to be considered as an exemplification of the principles of the invention and is not intended to limit the invention to the embodiments illustrated. It will be understood that like or analogous elements and components, referred to herein, may be identified throughout the drawings by like reference characters. In addition, it will be understood that the drawings are merely schematic representations of certain embodiments of the invention, and some of the components may have been distorted from their actual scale for purposes of pictorial clarity.

Referring now to the drawings generally, there is shown a push broom apparatus 10 according to the present invention. Push broom apparatus 10 is specifically engineered to address the significant limitations that have plagued conventional push broom designs for decades, providing a comprehensive solution that enhances structural integrity, eliminates the ergonomic burden of repetitive bending, and expands the functional capabilities of this essential cleaning implement. Push broom apparatus 10 achieves these objectives through the integration of a support brace 32 that simultaneously provides structural reinforcement at the critical head-to-handle connection point, enables the broom to stand upright independently in a freestanding upright orientation 50, and incorporates a scraper feature 46 for removal of adhered debris from surfaces.

The self-standing capability provided by support brace 32 represents a fundamental advancement in push broom design that delivers immediate and tangible benefits to users across residential, commercial, and industrial cleaning applications. When a user must pause sweeping operations—whether to take a break, move an obstacle, answer a question, attend to another task, or address any of the myriad interruptions that occur during a typical cleaning session—push broom apparatus 10 can be released in a freestanding upright orientation 50 without requiring the user to locate a wall, storage rack, or other external support structure. When ready to resume sweeping, the user simply grasps the handle and continues working. This eliminates the repetitive bending motion required to retrieve a floor-laid conventional broom, thereby reducing cumulative physical strain on the user's lower back, knees, and legs over extended work periods. In commercial and industrial environments where sweeping tasks may continue throughout an entire work shift, the elimination of dozens or even hundreds of bending motions per day represents a substantial improvement in worker comfort, health, and productivity.

The structural reinforcement provided by support brace 32 addresses another critical deficiency in conventional push broom construction. The head-to-handle connection point in traditional brooms represents a primary failure mode, with repetitive pushing and pulling forces causing gradual loosening, wobbling, and eventual separation. Support brace 32 distributes these forces across a broader area and provides a secondary load path that dramatically extends the operational lifespan of push broom apparatus 10. Users experience improved control during sweeping operations due to the enhanced rigidity of the connection, reducing fatigue and improving cleaning effectiveness.

The scraper feature 46 integrated into support brace 32 transforms push broom apparatus 10 into a multifunctional cleaning tool. Sweeping operations frequently encounter stuck-on materials, dried spills, compacted debris, and other adherent substances that resist removal by bristle action alone. With scraper feature 46 readily accessible on support brace 32, users can seamlessly transition between sweeping and scraping actions without changing implements, improving cleaning efficiency and eliminating the need to maintain and store separate scraping tools.

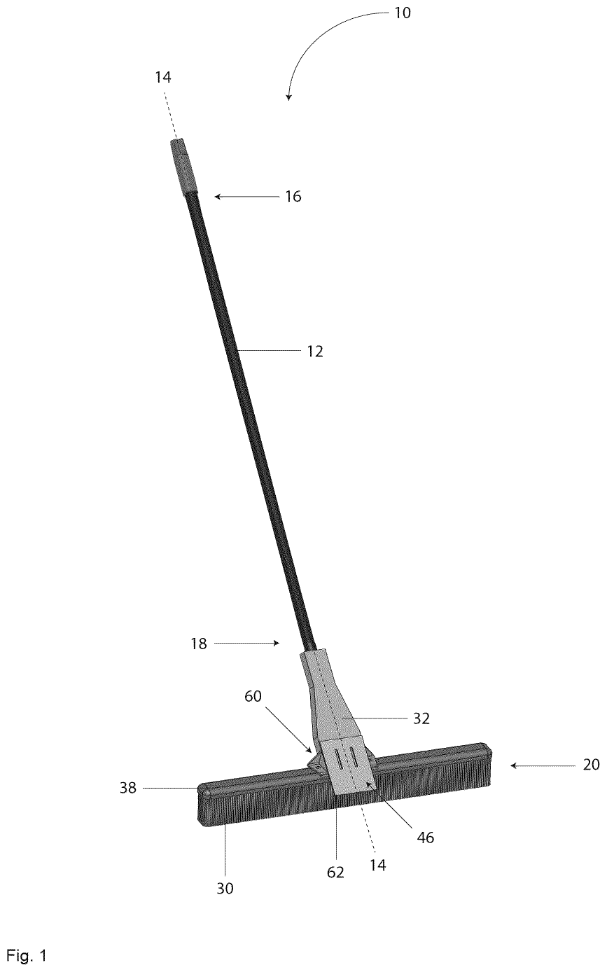

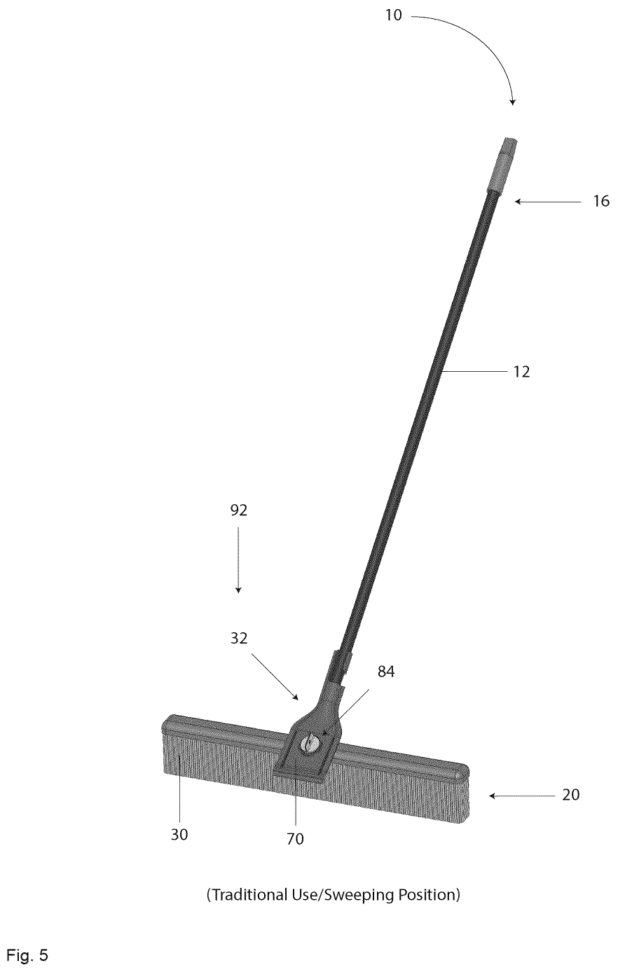

The present invention is disclosed herein in two principal embodiments. A first embodiment, shown in FIGS. 1-4, provides a fixed support brace configuration that offers simplicity of construction, reduced manufacturing cost, and robust durability with no moving parts. A second embodiment, shown in FIGS. 5-11, provides a pivoting support brace configuration that can be stowed during sweeping operations and deployed when self-standing capability is desired. Both embodiments share common structural elements and achieve the core objectives of the invention, differing primarily in the mechanism by which support brace 32 is positioned relative to the handle and broom head.

Referring now to FIGS. 1-11 collectively, push broom apparatus 10 includes an elongated handle 12 defining a handle axis 14. Handle 12 has a proximal end 16 configured for grasping by a user and a distal end 18 configured for connection to a broom head 20. Handle 12 may be constructed from any suitable material providing adequate strength, rigidity, and durability for the intended application, including but not limited to wood, metal, fiberglass, carbon fiber, or polymeric materials. In preferred embodiments, handle 12 has a length in the range of approximately 48 inches to approximately 60 inches, providing comfortable reach for users of varying heights while maintaining effective leverage during sweeping operations. Handle 12 may be of one-piece construction or may comprise multiple sections joined by threaded couplings, ferrules, or other connection mechanisms to facilitate storage and transport. The handle socket configuration accommodates handles of varying lengths, permitting selection of handle dimensions appropriate to the intended application and distribution channel. In certain commercial embodiments, handle length may be selected such that the assembled push broom apparatus fits within standard parcel shipping dimensions, reducing shipping costs and facilitating direct-to-consumer distribution.

Push broom apparatus 10 further includes broom head 20 connected to distal end 18 of handle 12. Broom head 20 has an upper surface 22, a lower surface 24, a first lateral end 26, and a second lateral end 28. Broom head 20 is elongated along an axis extending between first lateral end and second lateral end, with this axis being generally perpendicular to handle axis 14 when push broom apparatus 10 is in a normal use configuration. In preferred embodiments, broom head 20 has a width in the range of approximately 18 inches to approximately 36 inches, with widths of approximately 24 inches being particularly common for commercial applications. Broom head 20 may be constructed from wood, polymeric materials including polypropylene and polyethylene, metal, or composite materials, selected based on the intended application environment, durability requirements, and cost considerations.

A plurality of bristles 30 extend from the lower surface of broom head 20. Bristles 30 are configured to engage a surface to be cleaned and to sweep debris, dust, and other materials across that surface during cleaning operations. Bristles 30 may be constructed from natural materials such as palmyra, tampico, or horsehair, or from synthetic materials such as polypropylene, polyester, nylon, or polyvinyl chloride. The selection of bristle material is guided by the intended application, with stiffer bristles being preferred for outdoor surfaces, coarse debris, and heavy-duty applications, and softer bristles being preferred for smooth indoor surfaces and fine particle collection. Bristles 30 may be arranged in rows, tufts, or continuous strips, and may include bristles of varying stiffness levels arranged to optimize sweeping performance. In certain embodiments, bristles 30 may incorporate flagged or split tips to enhance fine particle collection. The length of bristles 30 is selected based on the intended application, with lengths in the range of approximately 2 inches to approximately 4 inches being typical for general-purpose push brooms.

Push broom apparatus 10 further includes support brace 32 having a first end portion 34 and a second end portion 36. First end portion 34 is connected adjacent a junction between handle 12 and broom head 20, and support brace 32 extends away from handle axis 14. Second end portion 36 is configured to engage a ground surface 48 to support push broom apparatus 10 in freestanding upright orientation 50. When push broom apparatus 10 is positioned in freestanding upright orientation 50, the weight of the apparatus is distributed between bristles 30 contacting ground surface 48 and second end portion 36 of support brace 32 contacting ground surface 48, creating a stable configuration that maintains the broom in an upright position without external support.

A mounting plate 38 is connected to first end portion 34 of support brace 32 and is secured to the upper surface of broom head 20 by at least one fastener 40. Mounting plate 38 distributes attachment forces across a broader area of broom head 20 than would a simple point connection, enhancing the structural integrity of the head-to-brace interface and reducing the likelihood of localized failure or pullout. Fasteners 40 may comprise screws, bolts, rivets, or other mechanical fastening elements, and in certain embodiments may be supplemented or replaced by adhesive bonding, welding, or snap-fit engagement depending on the materials of construction. In preferred embodiments, at least four fasteners 40 are employed to secure mounting plate 38 to broom head 20, providing redundancy and balanced load distribution.

A handle socket 42 is connected to mounting plate 38 and defines a non-circular aperture 44 configured to receive distal end 18 of handle 12 in a rotationally fixed relationship. The non-circular configuration of aperture 44 prevents relative rotation between handle 12 and support brace 32, ensuring that support brace 32 maintains its proper orientation relative to broom head 20 and bristles 30 during all phases of use. This anti-rotation feature is critical to proper operation of push broom apparatus 10, as rotation of handle 12 within handle socket 42 would cause support brace 32 to assume an unpredictable orientation, potentially interfering with sweeping operations and preventing proper achievement of freestanding upright orientation 50. In particularly preferred embodiments, non-circular aperture 44 is hexagonal, providing six-sided engagement between handle 12 and handle socket 42 that effectively resists rotational forces while permitting simple insertion and removal of handle 12 for replacement or storage purposes. Alternative non-circular configurations including square, octagonal, splined, keyed, and D-shaped profiles may be employed within the scope of the invention.

A scraper feature 46 is disposed on support brace 32 for removing adhered debris from surfaces. Scraper feature 46 enables users to address stuck-on materials, dried spills, compacted debris, and other adherent substances without requiring a separate scraping tool. During scraping operations, the user positions scraper feature 46 against the adhered material and applies downward and forward pressure through handle 12 to dislodge the material. The rigid connection between support brace 32 and broom head 20 via mounting plate 38 ensures that scraping forces are effectively transmitted and resisted without deflection or wobbling that would reduce scraping effectiveness.

Referring now to FIGS. 1-4, there is shown push broom apparatus 10 according to a first embodiment of the present invention. In the first embodiment, support brace 32 is fixedly connected to mounting plate 38 and extends at a predetermined angle relative to handle axis 14. The fixed configuration provides a simple, robust construction with no moving parts, minimizing manufacturing complexity, reducing production costs, and eliminating potential failure modes associated with pivoting mechanisms, springs, or locking devices. The first embodiment is particularly well-suited for cost-sensitive applications, environments where maximum durability is required, and users who prefer straightforward tool operation without adjustment requirements.

FIG. 1 shows push broom apparatus 10 according to the first embodiment in a use position suitable for sweeping operations. In the use position, handle 12 extends upwardly and rearwardly from broom head 20 at an angle comfortable for the user, and support brace 32 extends from mounting plate 38 at an angle that positions second end portion 36 above ground surface 48 and clear of the sweeping zone. Bristles 30 engage ground surface 48 to sweep debris in the direction of broom travel. During sweeping operations, support brace 32 does not interfere with the sweeping motion or contact ground surface 48, permitting full freedom of movement for effective cleaning action.

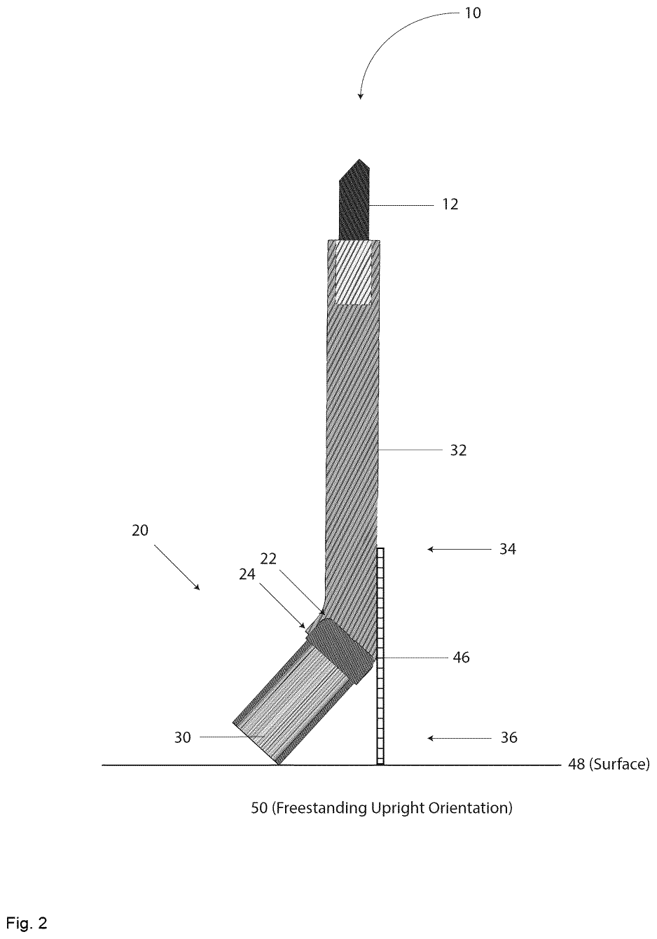

FIG. 2 shows push broom apparatus 10 according to the first embodiment in freestanding upright orientation 50. In this orientation, handle 12 extends generally upwardly from broom head 20, and support brace 32 extends at an acute angle relative to handle axis 14 such that second end portion 36 contacts ground surface 48 at a location spaced from broom head 20. The weight of push broom apparatus 10 is distributed between bristles 30 and second end portion 36 of support brace 32, creating a stable tripod-like configuration that maintains the broom in the upright position without external support. The user can transition push broom apparatus 10 from the use position of FIG. 1 to the freestanding upright orientation 50 of FIG. 2 simply by tilting the broom and releasing handle 12, without any adjustment of support brace 32 or actuation of any mechanism. This instant transition capability maximizes the efficiency benefit of the self-standing feature, enabling users to set down and retrieve the broom without bending and without any intermediate steps. The self-standing benefits illustrated in FIG. 2, including elimination of repetitive bending motions and improved workflow efficiency, apply equally to the second embodiment when brace member 70 is in deployed position 94.

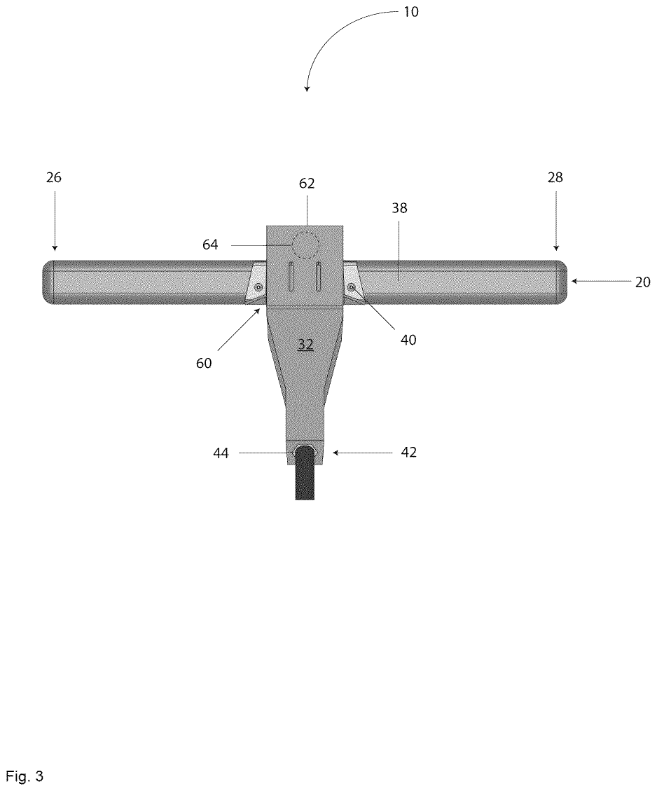

FIG. 3 is a top view of support brace 32 according to the first embodiment, showing mounting plate 38, and handle socket 42 defining non-circular aperture 44. As shown in FIG. 3, the first embodiment includes at least one reinforcement gusset 60 extending between support brace 32 and mounting plate 38. In the illustrated embodiment, two reinforcement gussets 60 are provided, one disposed on each lateral side of support brace 32 adjacent its junction with mounting plate 38. Reinforcement gussets 60 provide additional structural rigidity at the high-stress region where support brace 32 meets mounting plate 38, resisting bending forces that would otherwise concentrate at this junction. The triangular configuration of reinforcement gussets 60 efficiently transfers loads between support brace 32 and mounting plate 38 while minimizing material usage and weight. Reinforcement gussets 60 may be integrally formed with support brace 32 and mounting plate 38, or may be separately formed and attached by welding, adhesive bonding, mechanical fasteners, or other suitable joining methods.

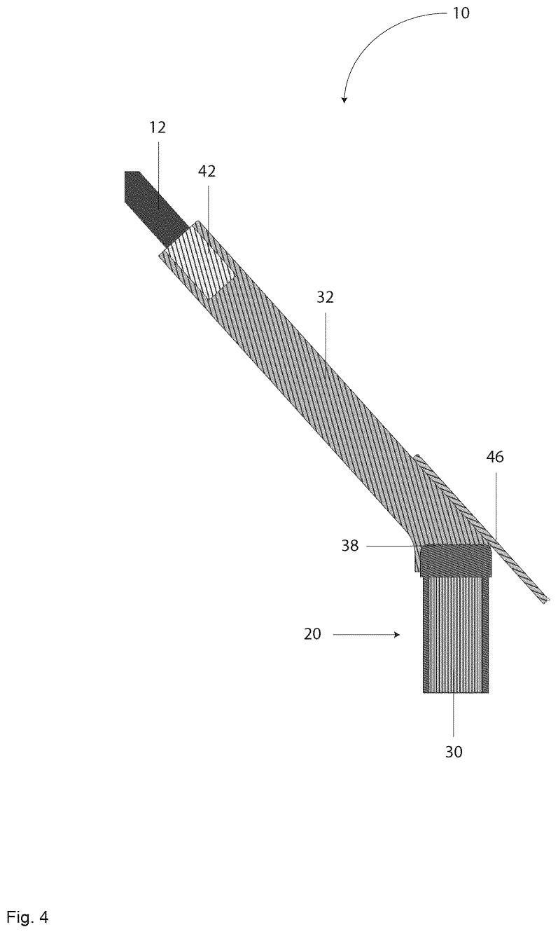

FIG. 4 is an enlarged side elevation view of push broom apparatus 10 according to the first embodiment, showing the internal structure of support brace 32 and its connection to broom head 20 and handle 12. As shown in FIG. 4, support brace 32 has a generally elongated configuration extending from first end portion 34 adjacent mounting plate 38 to second end portion 36 configured for ground engagement. Handle socket 42 extends upwardly from mounting plate 38 and receives distal end 18 of handle 12. The cross-sectional profile of handle socket 42 and handle 12 at this junction is non-circular, providing the rotationally fixed relationship described above.

In the first embodiment, scraper feature 46 comprises a scraper edge 62 formed integrally with support brace 32. Scraper edge 62 may be formed along a peripheral edge of support brace 32, providing a scraping surface that can be engaged with adhered debris by appropriately positioning push broom apparatus 10. The integral formation of scraper edge 62 eliminates the need for separate blade components and associated attachment mechanisms, contributing to the simplicity and durability that characterize the first embodiment. Scraper edge 62 may be sharpened or beveled during manufacture to enhance scraping effectiveness, and the material and heat treatment of support brace 32 may be selected to provide a scraper edge 62 of appropriate hardness and wear resistance.

Referring now to FIGS. 5-11, there is shown push broom apparatus 10 according to a second embodiment of the present invention. In the second embodiment, support brace 32 comprises a brace member 70 that is pivotably connected to mounting plate 38 and is movable between a stowed position 92 and a deployed position 94. The pivoting configuration provides enhanced versatility, permitting brace member 70 to be stowed generally parallel to handle 12 during sweeping operations to minimize interference, and to be deployed when the user wishes to position push broom apparatus 10 in freestanding upright orientation 50. The second embodiment is particularly well-suited for users who prefer a streamlined broom profile during active sweeping, applications requiring maximum maneuverability, and environments where the self-standing feature is used intermittently rather than continuously.

FIG. 5 is a perspective view of push broom apparatus 10 according to the second embodiment, showing the broom in a use position suitable for sweeping operations. In the use position, handle 12 extends upwardly and rearwardly from broom head 20 at an angle comfortable for the user, and brace member 70 is disposed in stowed position 92 generally parallel to handle 12. Bristles 30 engage ground surface 48 to sweep debris in the direction of broom travel. During sweeping operations, brace member 70 in stowed position 92 does not interfere with the sweeping motion, permitting full freedom of movement for effective cleaning action.

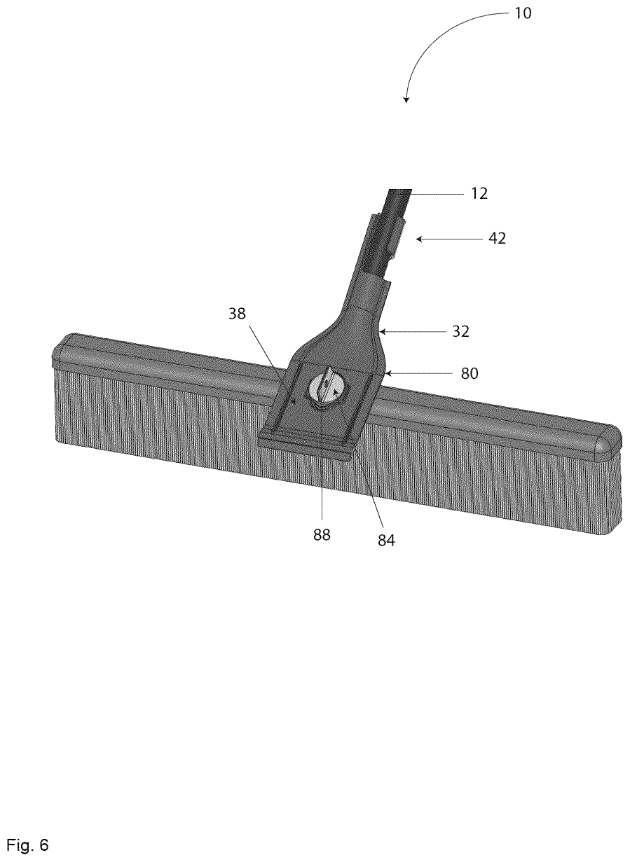

FIG. 6 is an enlarged perspective view of support brace 32 according to the second embodiment, showing mounting plate 38, handle socket 42, brace member 70, and cam lock mechanism 84. Brace member 70 has a proximal end 72 pivotably connected to mounting plate 38 at pivot connection 80, and a distal end 74 spaced from mounting plate 38 and configured for ground engagement. Pivot connection 80 permits brace member 70 to rotate between stowed position 92 and deployed position 94 about a pivot axis that extends generally parallel to the longitudinal axis of broom head 20. The pivot axis orientation ensures that brace member 70 swings in a plane generally perpendicular to the sweeping direction, avoiding interference with forward and rearward sweeping motions during transition between stowed and deployed positions.

The second embodiment includes a locking mechanism 82 configured to selectively secure brace member 70 in at least deployed position 94. Locking mechanism 82 ensures that brace member 70 remains in the intended position during use, preventing inadvertent movement that could compromise self-standing stability or interfere with sweeping operations. In the illustrated embodiment, locking mechanism 82 comprises cam lock mechanism 84 including a threaded fastener 86 and an actuating handle 88. Cam lock mechanism 84 provides rapid, tool-free transition between stowed position 92 and deployed position 94 through simple rotation of actuating handle 88. When actuating handle 88 is rotated to the locked orientation, cam lock mechanism 84 applies clamping force that secures brace member 70 in the selected position. When actuating handle 88 is rotated to the unlocked orientation, brace member 70 is free to pivot between stowed position 92 and deployed position 94.

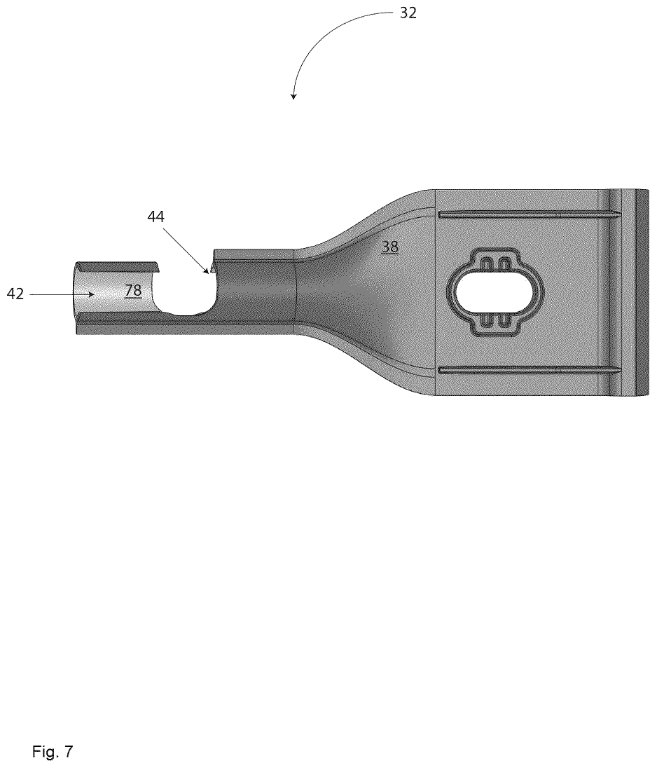

FIG. 7 is a top view of support brace 32 according to the second embodiment, showing handle socket 42 defining non-circular aperture 44 and a channel 78 formed in brace member 70. Non-circular aperture 44 is hexagonal in the illustrated embodiment, providing the rotationally fixed relationship between handle 12 and support brace 32 that ensures proper orientation of brace member 70 during all phases of use. Channel 78 is configured to receive handle 12 when brace member 70 is in stowed position 92. Channel 78 permits brace member 70 to nest closely against handle 12 during sweeping operations, minimizing the profile of the stowed brace member 70 and reducing the likelihood of interference with the user's grip or sweeping motion. The dimensions of channel 78 are selected to provide clearance for handle 12 while maintaining adequate structural material in brace member 70 for strength and rigidity.

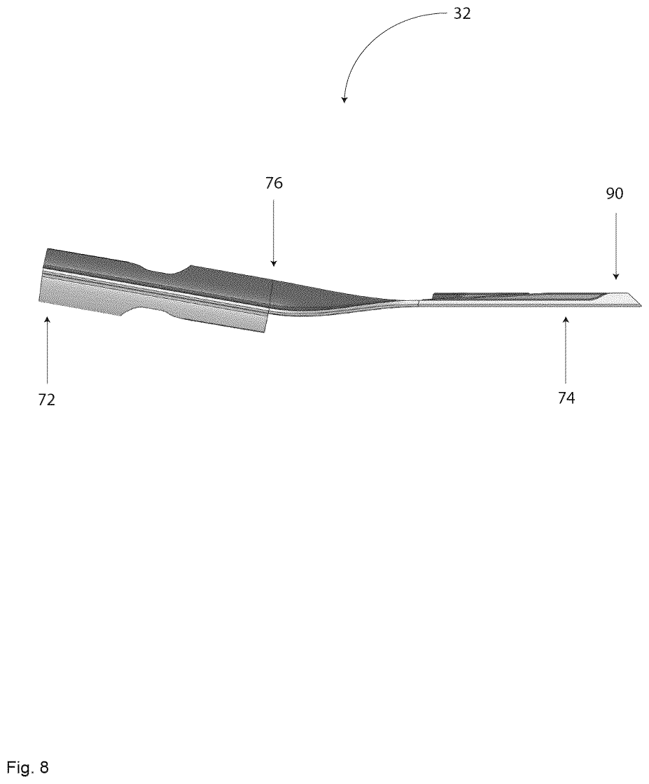

FIG. 8 is a side elevation view of brace member 70 according to the second embodiment, showing scraper blade 90 disposed at distal end 74 thereof. In the second embodiment, scraper feature 46 comprises scraper blade 90, which is a distinct component attached to brace member 70. Scraper blade 90 provides a dedicated scraping surface optimally positioned for engaging adhered debris when the user applies downward and forward pressure on handle 12. The blade configuration of scraper blade 90 permits selection of blade geometry, material, and edge treatment specifically optimized for scraping performance, independent of the material and configuration requirements of brace member 70 itself. Scraper blade 90 may be permanently attached to brace member 70, or may be removably attached as described below in connection with additional features of the invention.

As further shown in FIG. 8, brace member 70 includes a waisted portion 76 disposed between proximal end 72 and distal end 74. Waisted portion 76 provides a transition between a wider region at proximal end 72 where structural strength is required for the pivot connection and a narrower region extending toward distal end 74. The waisted configuration reduces material usage and weight while maintaining adequate structural strength throughout the length of brace member 70. The reduced width at waisted portion 76 also contributes to the streamlined profile of brace member 70 when in stowed position 92.

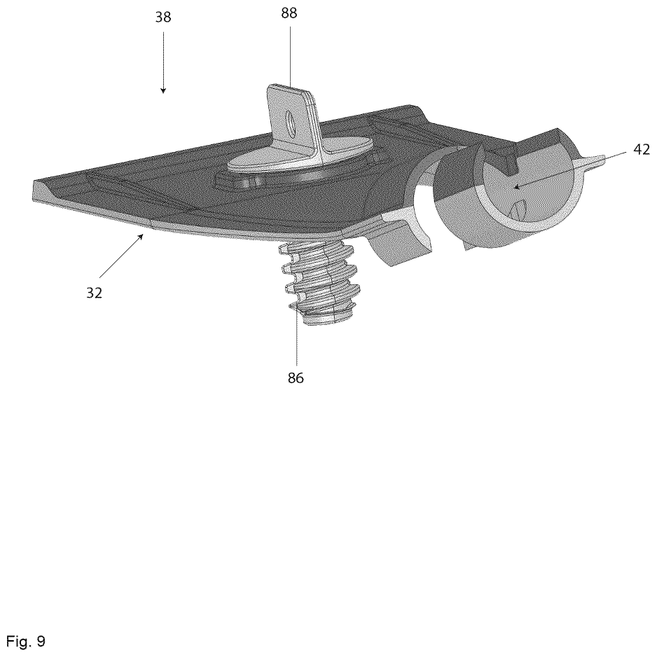

FIG. 9 is a bottom perspective view of support brace 32 according to the second embodiment, showing the underside of mounting plate 38 and cam lock mechanism 84. As shown in FIG. 9, threaded fastener 86 extends through mounting plate 38 and engages brace member 70 to selectively secure brace member 70 in the desired position. The cam surfaces of cam lock mechanism 84 are configured to apply progressively increasing clamping force as actuating handle 88 is rotated toward the locked orientation, and to release clamping force as actuating handle 88 is rotated toward the unlocked orientation.

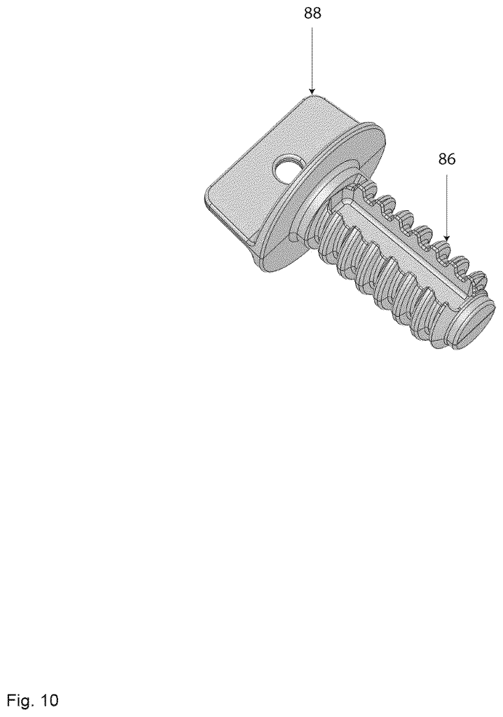

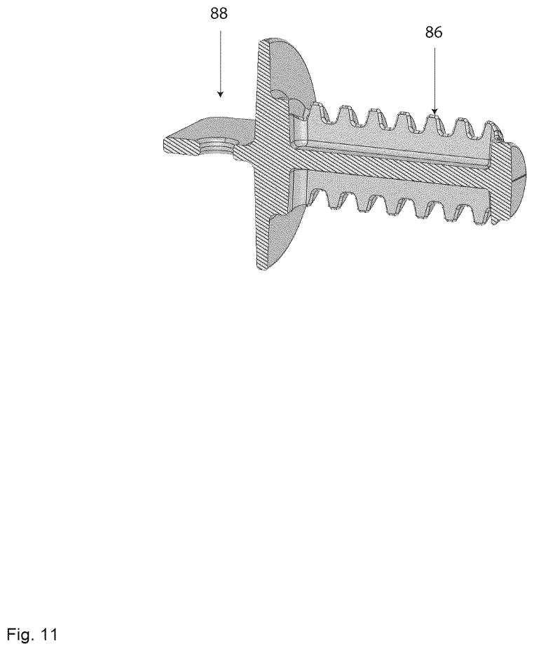

FIGS. 10 and 11 show cam lock fastener comprising actuating handle 88 and threaded fastener 86 in greater detail. FIG. 10 is a perspective view showing the overall configuration of the cam lock fastener, with actuating handle 88 providing a lever arm for manual rotation and threaded fastener 86 providing the clamping engagement with brace member 70. FIG. 11 is a cross-sectional view showing the internal structure of the cam lock fastener, including the thread profile of threaded fastener 86. The cam lock fastener configuration illustrated in FIGS. 10 and 11 provides reliable, repeatable locking action with simple one-handed operation, enabling users to rapidly transition between stowed position 92 and deployed position 94 without tools or complex manipulation.

In operation, a user of push broom apparatus 10 according to the second embodiment begins sweeping operations with brace member 70 in stowed position 92, wherein brace member 70 is disposed generally parallel to handle 12 and nested within channel 78 against the handle. The stowed configuration provides a streamlined profile that does not interfere with sweeping motions or catch on obstacles during use. When the user wishes to pause sweeping operations, the user rotates actuating handle 88 to unlock cam lock mechanism 84, pivots brace member 70 from stowed position 92 to deployed position 94, and rotates actuating handle 88 to lock cam lock mechanism 84 with brace member 70 in deployed position 94. The user then positions push broom apparatus 10 with distal end 74 of brace member 70 and bristles 30 both contacting ground surface 48, achieving freestanding upright orientation 50. When ready to resume sweeping, the user grasps handle 12 at proximal end 16, lifts push broom apparatus 10 from freestanding upright orientation 50, and continues sweeping. The user may optionally return brace member 70 to stowed position 92 for continued sweeping, or may leave brace member 70 in deployed position 94 if additional pauses are anticipated.

Push broom apparatus 10, and particularly support brace 32, mounting plate 38, and handle socket 42, may be constructed from a variety of materials selected for their combination of mechanical properties, durability, and cost-effectiveness appropriate to the intended application environment. Suitable materials include metals such as steel, stainless steel, aluminum, and zinc alloys; engineering thermoplastics such as acrylonitrile butadiene styrene (ABS), polyvinyl chloride (PVC), high-density polyethylene (HDPE), polypropylene (PP), acetal copolymer (POM), nylon (polyamide), and polycarbonate; fiber-reinforced polymer composites including glass-filled nylon and carbon fiber composites; and combinations of metallic and polymeric materials. The selection of material for a particular application is guided by the intended use environment, structural requirements, cost constraints, and manufacturing considerations.

In preferred embodiments for commercial and industrial applications where maximum durability is required, support brace 32 and mounting plate 38 are constructed from steel or aluminum, optionally with a protective coating such as powder coating, paint, zinc plating, or anodizing to enhance corrosion resistance and aesthetic appearance. The metallic construction provides high strength and stiffness, excellent fatigue resistance under cyclic loading, and a service life measured in years of heavy use. In preferred embodiments for residential and light-duty commercial applications where cost-effectiveness is prioritized, support brace 32 and mounting plate 38 are constructed from engineering thermoplastics, which can be economically manufactured by injection molding in high volumes while providing adequate strength and durability for the intended application.

Handle 12 may be constructed from wood, including hardwoods such as ash, hickory, and oak, or softwoods such as pine; from metal, including steel and aluminum tubing; from fiberglass; or from polymeric materials including polypropylene and polyvinyl chloride. Wooden handles provide a traditional appearance, comfortable grip, and natural shock absorption, and are readily available in standard dimensions compatible with conventional broom head connections. Metal handles provide enhanced durability and resistance to breakage, and may be selected for demanding commercial and industrial applications. Fiberglass handles provide excellent strength-to-weight ratio, electrical non-conductivity, and resistance to moisture and chemicals.

Broom head 20 may be constructed from wood, polymeric materials, or metal, with polymeric materials including polypropylene being preferred for resistance to moisture, chemicals, and impact damage. Bristles 30 may be attached to broom head 20 by stapling, adhesive bonding, heat fusion, or mechanical retention in molded sockets, depending on the materials of construction and manufacturing process employed.

In operation, a user employs push broom apparatus 10 in a method of cleaning a surface that takes full advantage of the self-standing capability, structural reinforcement, and scraper feature provided by the present invention.

The method begins with providing push broom apparatus 10 including handle 12 connected to broom head 20 having bristles 30, and support brace 32 connected adjacent the junction between handle 12 and broom head 20. The user grasps handle 12 at or near proximal end 16 and positions bristles 30 in contact with ground surface 48 or other surface to be cleaned.

The user sweeps the surface by moving push broom apparatus 10 in pushing and/or pulling motions, with bristles 30 engaging debris and transporting the debris across the surface toward a collection point. The enhanced structural rigidity provided by support brace 32 and mounting plate 38 ensures that push broom apparatus 10 responds predictably to user inputs without wobbling or flexing at the head-to-handle connection point. This improved rigidity reduces user fatigue and enhances cleaning effectiveness by permitting more precise control of bristle engagement and sweeping motion.

When the user encounters adhered debris that resists removal by bristle action, the user employs scraper feature 46 to dislodge the adhered material. The user positions scraper feature 46 against the adhered debris and applies downward and forward pressure through handle 12, using the rigid structure of push broom apparatus 10 to transmit scraping forces effectively. The adhered debris is dislodged from the surface and can then be swept away with bristles 30 in the normal manner. The ability to seamlessly transition between sweeping and scraping without changing tools significantly improves cleaning efficiency and reduces the time required to address diverse debris types.

When the user wishes to pause sweeping operations, the user orients push broom apparatus 10 such that support brace 32 extends away from handle 12 at an angle suitable for ground engagement. For push broom apparatus 10 according to the second embodiment, this may involve moving brace member 70 from stowed position 92 to deployed position and the actuating locking mechanism to secure brace member 70 in deployed position 94. The user then releases push broom apparatus 10, whereby second end portion 36 of support brace 32 engages ground surface 48 and push broom apparatus 10 remains in freestanding upright orientation 50.

With push broom apparatus 10 standing freely, the user can attend to other tasks, take a break, move obstacles, answer questions, or address any other matter requiring attention without concern for the disposition of the broom. Importantly, the user need not walk to a wall or storage location to lean the broom, and need not lay the broom on the ground where it would require bending to retrieve.

When ready to resume sweeping, the user simply grasps handle 12 at or near proximal end 16 and lifts push broom apparatus 10 from freestanding upright orientation 50. The user's back, knees, and legs are spared the strain of bending to retrieve a floor-laid broom. Over the course of a work shift involving many pauses and resumptions, the cumulative ergonomic benefit is substantial. The user may resume sweeping immediately, or may first return brace member 70 to stowed position 92 if the second embodiment is employed and a streamlined profile is desired.

Upon completion of cleaning operations, push broom apparatus 10 may be stored in freestanding upright orientation 50, leaned against a wall, placed in a storage rack, or hung from a hook or nail using features described below. The self-standing capability provides storage flexibility that conventional brooms cannot match, enabling push broom apparatus 10 to be stored in locations where walls or storage infrastructure are not available.

Push broom apparatus 10 may incorporate various additional features and enhancements that further improve functionality, convenience, durability, and user experience. These features may be incorporated in either the first embodiment or the second embodiment, or in alternative embodiments combining elements of both.

In certain embodiments, support brace 32 includes a hanging aperture 64 configured to receive a hook, nail, or other support element for wall-mounted storage. Hanging aperture 64 may be circular, teardrop-shaped, or keyhole-shaped, and is preferably disposed at or adjacent scraper edge 62 where it does not interfere with ground engagement during self-standing use. The provision of hanging aperture 64 provides dual storage capability: push broom apparatus 10 can stand freely in freestanding upright orientation 50 in open areas where walls are not accessible, and can alternatively be hung from a wall hook or nail in storage closets, utility rooms, garages, or other locations where wall-mounted storage is preferred.

In certain embodiments, second end portion 36 of support brace 32 includes an elastomeric foot pad configured for ground engagement. The elastomeric foot pad may be constructed from rubber, thermoplastic elastomer, thermoplastic polyurethane, or other resilient materials providing cushioning and grip characteristics. The elastomeric foot pad protects flooring surfaces from scratching or marring, provides enhanced grip on smooth surfaces, and reduces noise associated with brace contact during positioning and storage. The elastomeric foot pad may be permanently attached or removably attached to permit replacement when worn.

In certain embodiments, handle 12 includes an ergonomic grip sleeve disposed at or adjacent proximal end 16. The ergonomic grip sleeve may be constructed from foam, rubber, silicone, thermoplastic elastomer, or other cushioning materials that reduce hand fatigue and improve grip security during extended use. The cushioning absorbs vibration and impact during sweeping operations, further reducing user fatigue.

In certain embodiments, bristles 30 incorporate an antimicrobial treatment that inhibits the growth of bacteria, mold, mildew, and other microorganisms on bristle surfaces. The antimicrobial treatment may comprise silver ions, zinc pyrithione, quaternary ammonium compounds, or other antimicrobial agents. The antimicrobial properties are particularly valuable in food service, healthcare, pharmaceutical, and cleanroom applications where hygiene is critical.

In certain embodiments, scraper feature 46 comprises a replaceable scraper blade removably attached to support brace 32 or brace member 70. The replaceable scraper blade may be retained by a slot, clip, screw, or other fastening mechanism that permits removal and replacement without tools. The replaceable configuration extends service life and enables users to select blade configurations optimized for particular scraping tasks.

In certain embodiments, support brace 32 or handle 12 includes a reflective strip configured to enhance visibility in low-light conditions, or measurement markings disposed along the length of handle 12 enabling users to employ push broom apparatus 10 as a convenient measuring reference.

The foregoing description merely explains and illustrates the invention and the invention is not limited thereto except insofar as the appended claims are so limited, as those skilled in the art who have the disclosure before them will be able to make modifications without departing from the scope of the invention.

While certain embodiments have been illustrated and described, it should be understood that changes and modifications can be made therein in accordance with ordinary skill in the art without departing from the technology in its broader aspects as defined in the following claims.

The embodiments illustratively described herein may suitably be practiced in the absence of any element or elements, limitation or limitations, not specifically disclosed herein. Thus, for example, the terms “comprising,” “including,” “containing,” and the like shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular systems and methods. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, and the like. As a non-limiting example, each range discussed herein can be readily broken down into a lower third, middle third, and upper third, and the like. As will also be understood by one skilled in the art, all language such as “up to,” “at least,” “greater than,” “less than,” and the like include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed and desired to be secured by letters patent of the United States is:

1. A push broom apparatus, comprising:
an elongated handle defining a handle axis and having a proximal end and a distal end;
a broom head connected to said distal end of said handle, said broom head having a plurality of bristles extending therefrom; and
a support brace having a first end portion and a second end portion, said first end portion being connected adjacent a junction between said handle and said broom head, said support brace extending away from said handle axis, wherein said second end portion is configured to engage a ground surface to support said push broom apparatus in a freestanding upright orientation.

2. The push broom apparatus according to claim 1, further comprising a handle socket disposed at said first end portion of said support brace, said handle socket defining a non-circular aperture configured to receive said distal end of said handle in a rotationally fixed relationship.

3. The push broom apparatus according to claim 1, wherein said support brace includes a scraper edge configured for removing adhered debris from a surface, said scraper edge defining a hanging aperture configured to receive a hook for wall-mounted storage.

4. The push broom apparatus according to claim 1, further comprising a mounting plate connected to said first end portion of said support brace, said mounting plate being secured to said broom head by at least one fastener.

5. The push broom apparatus according to claim 4, further comprising at least one reinforcement gusset extending between said support brace and said mounting plate.

6. The push broom apparatus according to claim 1, wherein said support brace extends at an acute angle relative to said handle axis when said push broom apparatus is in said freestanding upright orientation.

7. The push broom apparatus according to claim 1, wherein said support brace is movable between a stowed position wherein said support brace is disposed generally parallel to said handle and a deployed position wherein said support brace extends away from said handle axis to enable said freestanding upright orientation.

8. A push broom apparatus, comprising:
an elongated handle defining a handle axis and having a proximal end and a distal end; a broom head connected to said distal end of said handle, said broom head having an upper surface, a lower surface, and a plurality of bristles extending from said lower surface;
a support brace assembly including:
a mounting plate configured for attachment to said upper surface of said broom head;
a handle socket connected to said mounting plate and defining a non-circular aperture configured to receive said distal end of said handle in a rotationally fixed relationship;
a brace member having a proximal end connected to said mounting plate and a distal end spaced from said mounting plate, said brace member extending away from said handle axis; and
a scraper feature disposed on said brace member; and wherein said distal end of said brace member is configured to engage a ground surface to support said push broom apparatus in a freestanding upright orientation.

9. The push broom apparatus according to claim 8, wherein said brace member is pivotably connected to said mounting plate and is movable between a stowed position and a deployed position.

10. The push broom apparatus according to claim 9, further comprising a locking mechanism configured to selectively secure said brace member in at least said deployed position.

11. The push broom apparatus according to claim 10, wherein said locking mechanism comprises a cam lock including a threaded fastener and an actuating handle.

12. The push broom apparatus according to claim 8, wherein said scraper feature comprises a scraper blade disposed at said distal end of said brace member.

13. The push broom apparatus according to claim 8, wherein said scraper feature comprises a scraper edge formed integrally with said brace member.

14. The push broom apparatus according to claim 8, wherein said non-circular aperture is hexagonal.

15. A push broom consisting of:
an elongated handle defining a handle axis and having a proximal end, a distal end, and a non-circular cross-sectional profile at said distal end;
a broom head having an upper surface, a lower surface, a first lateral end, and a second lateral end;
a plurality of bristles extending from said lower surface of said broom head;
a support brace assembly including:
a mounting plate secured to said upper surface of said broom head;
a handle socket connected to said mounting plate and defining a hexagonal aperture sized to receive said distal end of said handle in a rotationally fixed relationship;
a brace member pivotably connected to said mounting plate and movable between a stowed position wherein said brace member is disposed generally parallel to said handle and a deployed position wherein said brace member extends at an acute angle relative to said handle axis;
a cam lock mechanism including a threaded fastener extending through said mounting plate and an actuating handle connected to said threaded fastener, said cam lock mechanism configured to selectively secure said brace member in said deployed position; and
a scraper blade disposed at a distal end of said brace member;
wherein in said deployed position said distal end of said brace member is configured to engage a ground surface to support said push broom in a freestanding upright orientation with said bristles contacting said ground surface.

16. The push broom according to claim 15, wherein said brace member includes a waisted portion disposed between said proximal end and said distal end thereof.

17. The push broom according to claim 15, wherein said brace member defines a channel configured to receive said handle when said brace member is in said stowed position.

18. A method of using a push broom, comprising the steps of:
providing a push broom apparatus including an elongated handle connected to a broom head having a plurality of bristles, and a support brace connected adjacent a junction between said handle and said broom head;
sweeping a surface with said plurality of bristles;
orienting said push broom apparatus such that said support brace extends away from said handle; and
releasing said push broom apparatus whereby said support brace engages said surface and said push broom apparatus remains in a freestanding upright orientation.

19. The method according to claim 18, further comprising the step of scraping adhered debris from said surface using a scraper feature disposed on said support brace.

20. The method according to claim 18, further comprising the steps of: moving said support brace from a stowed position to a deployed position prior to said releasing step; and actuating a locking mechanism to secure said support brace in said deployed position.
